(19) United States
(12) Patent Application Publication
(10) Pub. No.: US 2020/0126330 A1
(43) Pub. Date: Apr. 23, 2020

(54) TIRE INSPECTION SYSTEM FOR VEHICLE FLEETS

(71) Applicant: The Goodyear Tire & Rubber Company, Akron, OH (US)

(72) Inventors: Jamie Lynn Wofford-Redmond, Akron, OH (US); Johnny Lee McIntosh, Uniontown, OH (US); Michele Lee Root, Medina, OH (US); Joshua Kenneth Wright, Macedonia, OH (US)

(21) Appl. No.: 16/164,967

(22) Filed: Oct. 19, 2018

(51) Int. Cl. G07C 5/08; G07C 5/00

(52) U.S. Cl. CPC G07C 5/0866; G07C 5/008

(57) ABSTRACT

An inspection system for a tire of a vehicle in a fleet includes a portable inspection device that includes means for measuring a tire pressure, means for measuring a tread depth of the tire, and an antenna for wireless communication. A hand-held data device includes a processor, memory and an antenna. The data device receives the measured tire pressure and the measured tread depth of the tire from the portable inspection device. A server is remote from the data device and a first wireless transmission means uploads the measured tire pressure and the measured tread depth of the tire from the data device to the server. An analysis device is in electronic communication with the server for analysis of the data uploaded from the data device. A second wireless transmission means communicates cloned data sets from the server to the data device. A method for inspecting is also provided.

### FIELD OF THE INVENTION

The invention relates to pneumatic tires for vehicles and the inspection of such tires in vehicle fleets. More particularly, the invention is directed to a system for the inspection of tires in a fleet of vehicles that includes real-time gathering of tire data and efficient management of data to provide an easily executed and rapid tire inspection with objective and consistent data.

### BACKGROUND OF THE INVENTION

In the pneumatic tire art, tires are often employed on fleets of vehicles. Such fleets include commercial vehicles, such as tractor-trailers, heavy-duty trucks, dump trucks and the like, as well as lighter-duty trucks and automobiles. For the purpose of convenience, reference herein shall be made to the term vehicle with the understanding that such reference applies to commercial trucks, lighter-duty trucks and automobiles. A primary consideration for a fleet of vehicles is optimizing the amount of time that each vehicle is in service. To this end, it is desirable to inspect the tires of each vehicle to check tire pressure, tread depth and the general condition of each tire and ensure that the tire is ready for continued service.

Such inspection is often performed when respective vehicles of the fleet are parked in a lot or facility where a technician can inspect the tires. In the inspection process, one or more technicians move from vehicle to vehicle to check the pressure and tread depth of each tire, while also visually checking the appearance and overall condition of each tire. If any issues are discovered, such as a tire with tread depth below a minimum acceptable level or a pressure leak, the tire is designated for repair or replacement before the vehicle is returned to service. In addition, periodic reports of the condition of each tire enable data to be generated and analyzed that may enable central review of tire performance and/or a pro-active recommendation for repair and/or replacement, thereby minimizing potential downtime of the vehicle.

In the prior art, the above-described information for each tire was recorded by the technician on a sheet of paper. When central analysis was required, the paper records were brought to a data entry clerk, who transcribed the information into a computer system for sending to a manager or a data review service to generate recommendations regarding tires to be repaired or replaced. Such paper records allow for error in data transcription, undesirably leading to inconsistent results.

Systems have been developed in the prior art that include the use of electronic tools to measure tire pressure and gauge tread depth. However, certain data, such as an overall view of the tire, was described in writing by the technician, resulting in subjectivity in the evaluation of the tire. In addition, data regarding the overall fleet and each vehicle, as well as certain static data for each tire, must be entered repeatedly in such systems, which is inefficient and may lead to errors. Subjectivity in evaluation and repeated data entry may again undesirably lead to inconsistent results.

In addition, for a fleet of vehicles, large amounts of tire data are often analyzed to provide optimum recommendations for tire repair and/or replacement. When large amounts of data are analyzed, objectivity and consistency are important, as objectivity and consistency produce more accurate data, which in turn enables improved analysis and recommendations.

As a result, there is a need in the art for a system for the inspection of tires in a fleet of vehicles that includes real-time gathering of tire data and efficient management of data to provide an easily-executed and rapid tire inspection, and which also provides objective and consistent data.

### SUMMARY OF THE INVENTION

According to an aspect of an exemplary embodiment of the invention, an inspection system for a tire of a vehicle in a fleet includes a portable inspection device that includes means for measuring a tire pressure, means for measuring a tread depth of the tire, and an antenna for wireless communication. A hand-held data device includes a processor, memory and an antenna for wireless data transmission, in which the data device receives the measured tire pressure and the measured tread depth of the tire from the portable inspection device. A server is remote from the data device and a first wireless transmission means uploads the measured tire pressure and the measured tread depth of the tire from the data device to the server. An analysis device is in electronic communication with the server for analysis of the data uploaded from the data device, and a second wireless transmission means communicates cloned data sets from the server to the data device.

According to another aspect of an exemplary embodiment of the invention, a method for inspecting a tire of a vehicle in a fleet includes the step of determining if the inspection is a first inspection for the fleet. If the inspection is a first inspection for the fleet, fleet data is entered into a hand-held data device. It is also determined if the inspection is a first inspection for the vehicle. If the inspection is a first inspection for the vehicle, vehicle data is entered into the data device and static tire data is entered into the data device. If the inspection is not a first inspection for the fleet and the vehicle, previously-entered fleet data, vehicle data and static tire data is cloned on the data device. A tire representation is selected on the data device that corresponds to the tire to be inspected, and an inflation pressure and a tread depth of the tire to be inspected is measured with a portable inspection device. The measured inflation pressure and tread depth are transmitted from the portable inspection device to the data device. The measured inflation pressure and tread depth are correlated to the selected tire representation on the data device, and the fleet data, vehicle data, static tire data, the measured inflation pressure and the measured tread depth are transmitted to a remote server.

### Definitions

The following definitions are applicable to the present invention.

“Axial” and “axially” mean lines or directions that are parallel to the axis of rotation of the tire.

“Circumferential” means lines or directions extending along the perimeter of the surface of the annular tread perpendicular to the axial direction.

“Equatorial plane” means the plane perpendicular to the axis of rotation of the tire and passing through the center of the tire tread.

“Footprint” means the contact patch or area of contact created by the tire tread with a flat surface as the tire rotates or rolls.

“Inboard side” means the side of the tire nearest the vehicle when the tire is mounted on a wheel and the wheel is mounted on the vehicle.

“Inner” means toward the inside of the tire.

“Lateral” and “laterally” are used to indicate axial directions across the tread of the tire.

“Lateral edges” means a line tangent to the axially outermost tread contact patch or footprint as measured under normal load and tire inflation, the lines being parallel to the equatorial centerplane.

“Outboard side” means the side of the tire farthest away from the vehicle when the tire is mounted on a wheel and the wheel is mounted on the vehicle.

“Outer” means toward the outside of the tire.

“Radial” and “radially” are used to mean directions radially toward or away from the axis of rotation of the tire.

“Tread” means a molded rubber component which includes that portion of the tire that comes into contact with the road when the tire is normally inflated and under normal load.

### BRIEF DESCRIPTION OF THE DRAWINGS

The invention will be described by way of example and with reference to the accompanying drawings, in which:

FIG. 1 is a side elevational view of an exemplary vehicle for use with the tire inspection system of the present invention;

FIG. 2 is a schematic diagram of an exemplary embodiment of the tire inspection system of the present invention;

FIG. 3 is a flow diagram illustrating steps of the tire inspection system shown in FIG. 2;

FIG. 4a is a schematic representation of a first display screen of a data device in a fleet data entry portion of the system shown in FIGS. 2 and 3;

FIG. 4b is a schematic representation of a second display screen of a data device in a fleet data entry portion of the system shown in FIGS. 2 and 3;

FIG. 4c is a schematic representation of a third display screen of a data device in a fleet data entry portion of the system shown in FIGS. 2 and 3;

FIG. 5a is a schematic representation of a first display screen of a data device in a vehicle or unit data entry portion of the system shown in FIGS. 2 and 3;

FIG. 5b is a schematic representation of a second display screen of a data device in a vehicle or unit data entry portion of the system shown in FIGS. 2 and 3;

FIG. 6 is a schematic representation of a display screen of a data device in a cloning portion of the system shown in FIGS. 2 and 3;

FIG. 7a is a schematic representation of a first display screen of a data device in a static tire data entry portion of the system shown in FIGS. 2 and 3;

FIG. 7b is a schematic representation of a second display screen of a data device in a static tire data entry portion of the system shown in FIGS. 2 and 3; and

FIG. 8 is a schematic representation of a display screen of a data device in a measured tire data entry portion of the system shown in FIGS. 2 and 3.

Similar numerals refer to similar parts throughout the drawings.

### DETAILED DESCRIPTION OF THE INVENTION

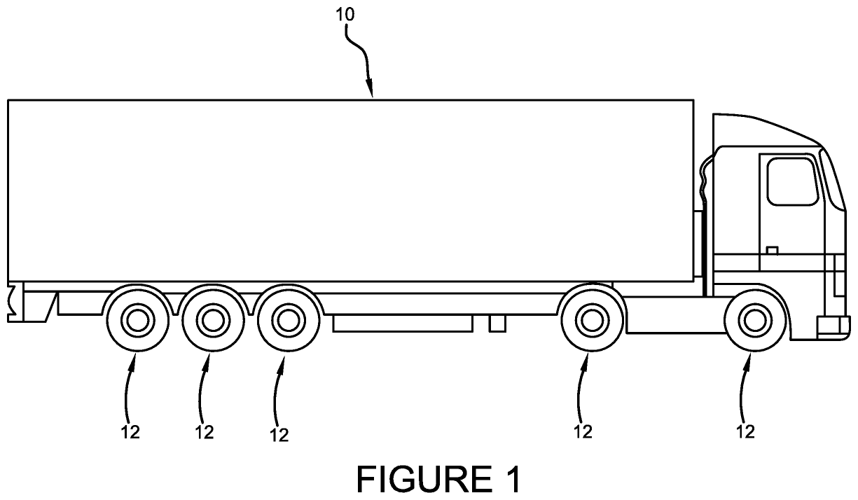

With reference to FIG. 1, an exemplary vehicle in a fleet for use with the tire inspection system of the present invention is indicated at 10. The vehicle 10 includes multiple tires 12, each of which is inspected when the vehicle is parked in a fleet lot or facility.

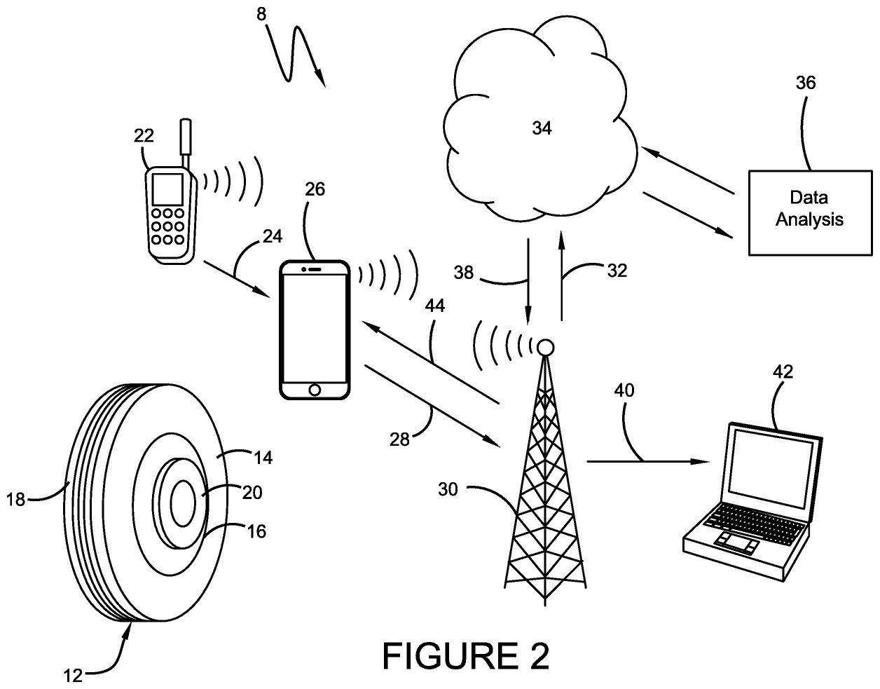

Turning now to FIG. 2, each tire 12 includes a pair of sidewalls 14 (only one shown) extending from respective bead areas 16 (only one shown) to a ground-engaging tread 18. The tire 12 is mounted on a wheel 20 as known to those skilled in the art and defines an internal cavity that is inflated with air. When the tire 12 is inspected, the depth of the tread 18 is checked by a technician to ensure that it is above a minimum level. If the depth of the tread 18 is below the minimum level, it is recommended that the tire 12 be replaced. The air pressure of the tire 12 is also checked to ensure that the pressure is at or near a recommended or target level. If the pressure is too far below the target level, the tire 12 may need to be repaired and/or replaced. Also, the overall condition of the tire 12 is reviewed by the technician to determine if any issues are present that may dictate repair and/or replacement of the tire, such as damage to one of the sidewalls 14 and/or the tread 18.

An exemplary embodiment of the tire inspection system of the present invention is indicated at 8, and includes a portable inspection device 22 carried by a technician to measure the pressure and tread depth of the tire 12. More particularly, the portable inspection device 22 is a hand-held unit that preferably includes a chuck to engage a tire valve of the tire 12 to measure the tire pressure. The portable inspection device 22 also includes pins to measure the depth of grooves in the tread 18 and thus the tread depth through contact-based means, or optical or laser sensors to measure the depth of the tread grooves and thus the tread depth through non-contact means. Preferably, the portable inspection device 22 includes an antenna for wireless communication 24, such as Bluetooth communication, to send the measured tire data of pressure and tread depth to a data device 26.

The data device 26 preferably is a programmable hand-held unit with a processor, memory and an antenna for wireless data transmission, and thus is capable of receiving, storing and transmitting data. Preferably, the data device 26 is a smartphone that includes a program, such as a computer application or app, which is configured to receive the measured tire data of pressure and tread depth from the portable inspection device 22 and other data to be described below. The data device 26 preferably receives the measured tire pressure and tread depth from the inspection device 22 and correlates the measured tire pressure and tread depth to a unique identification code for the tire 12 that is being inspected, which is known as a tire ID.

The data device 26 acquires the tire ID in any one of several ways. If the tire 12 is equipped with a radio frequency identification (RFID) tag, the data device 26 may scan the RFID tag to acquire the tire ID, or may receive the tire ID from a separate scanning unit. When the tire 12 includes a bar code on a sidewall 14 instead of an RFID tag, the data device 26 scans or captures an image of the bar code. The bar code contains the tire ID and enables it to be uploaded to the data device 26. The tire sidewall 14 also includes a Department of Transportation (DOT) code, which includes information such as the manufacturing plant code, manufacture date, brand data, and the like. Thus, if the tire 12 does not include an RFID tag or a bar code, the DOT code may be entered into the data device 26 to enable the tire ID to be acquired by the device.

The data device 26 may also include a camera to capture an image of the tire 12 being inspected. An image may be required for each tire 12, or only when the technician believes there may be an issue or damage to a tire sidewall 14 and/or the tread 18. The image is acquired by the data device 26 for uploading with the measured data of pressure and tread depth, along with the tire ID.

The data acquired by the data device 26 is uploaded by wireless transmission 28 to an antenna 30 for further transmission 32 to a central server 34, which preferably is a cloud-based server. The server 34 receives the measured data of pressure and tread depth, as well as any image, for each respective tire 12 as correlated to the tire ID. In addition, other data to be described below if transmitted to the server 34 from the data device 34. The 34 stores the data sent by the data device 26. Upon request, the server 34 communicates the data to a data analysis device 36, such as a third-party computer system, for analysis of the data sent by the data device 26. Once the data is analyzed, recommendations and/or selected data sets are sent from the data analysis device 36 to the server 34. The server 34 transmits the recommendations and/or selected data sets by wireless transmission 38 to the antenna 30, and by further wireless transmission 40 to a managerial device 42 for the fleet. Receipt of such information by the managerial device 42 enables any recommendations to be implemented, such as pro-active repair and/or replacement of certain tires 12.

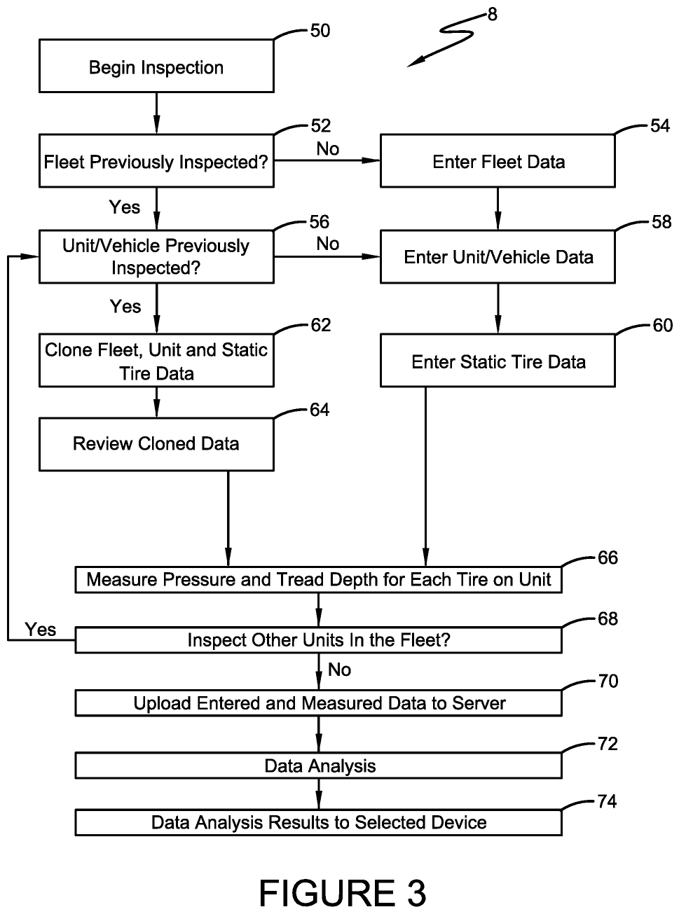

Selected data sets may also be wirelessly transmitted 44 to the data device 26 for cloning of data to provide an easy and rapid inspection with improved data accuracy and consistency. Referring now to FIG. 3, steps of the exemplary embodiment of the tire inspection system 8 are shown. In step 50, the technician begins the inspection of the tires 12 of selected vehicles 10 (FIG. 1). Using the data device 26 (FIG. 2), the technician determines at step 52 if the inspection is a first inspection for this fleet, or if this fleet has been inspected before.

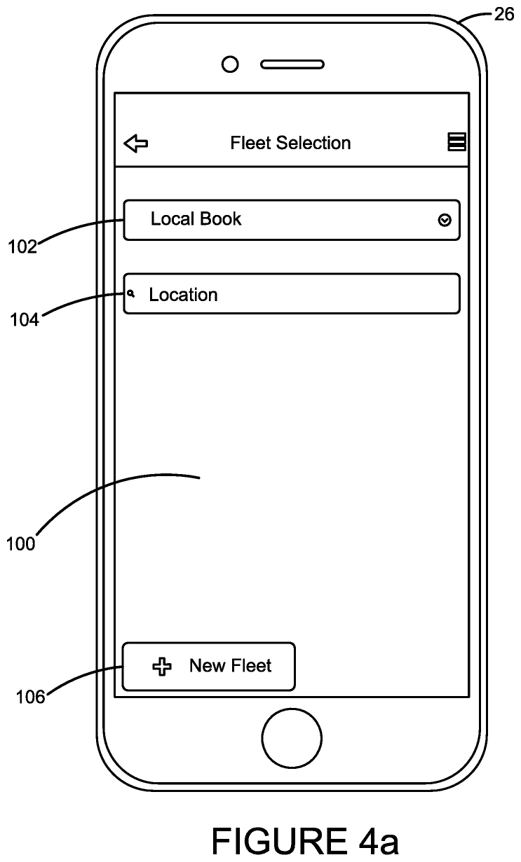

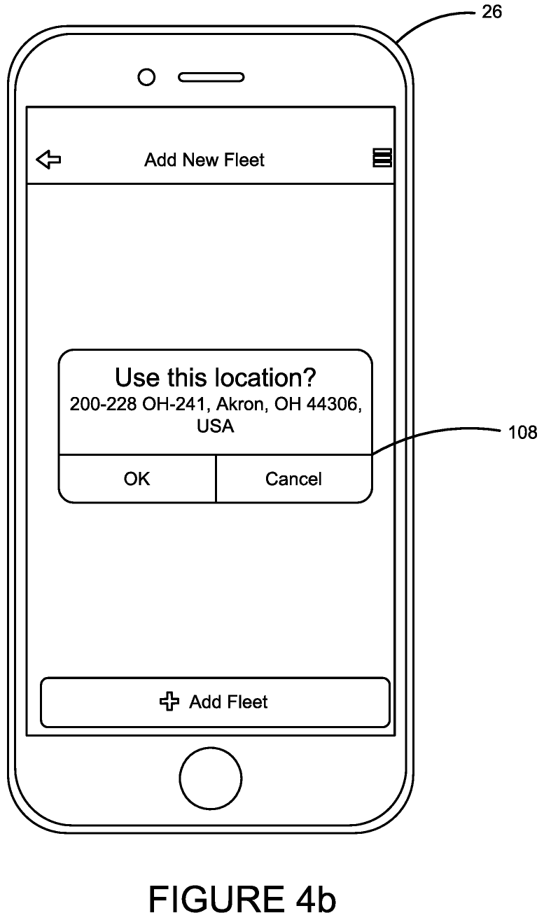

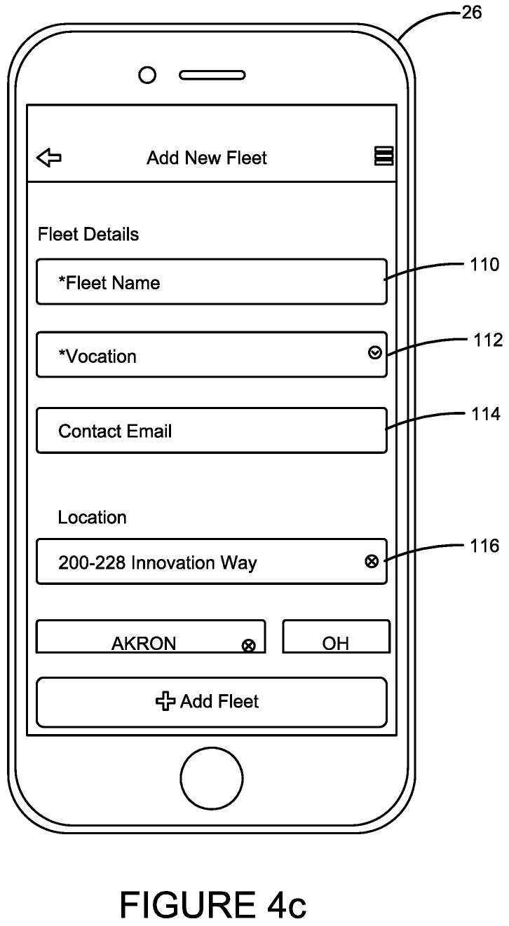

With additional reference to FIG. 4a, if this fleet has been inspected before, the technician confirms on an initial fleet display screen 100 of the data device 26 a stored name 102 and/or location of the fleet lot 104. If this fleet has not been inspected before, the technician proceeds through a new fleet function 106 to a fleet data entry screen 108 on the data device 26, shown in FIG. 4b. For entry of new fleet information, step 54 (FIG. 3), the data device 26 preferably is equipped with a global positioning system (GPS). The GPS enables the geographic location of the technician in the lot 108 to be acquired and stored as an initial fleet location in the data device. The GPS location 108 may be converted to a street address 116 as shown in FIG. 4c, and the technician may enter additional fleet-related data, such as a fleet name 110, vocation or type of fleet 112 and/or fleet contact information 114.

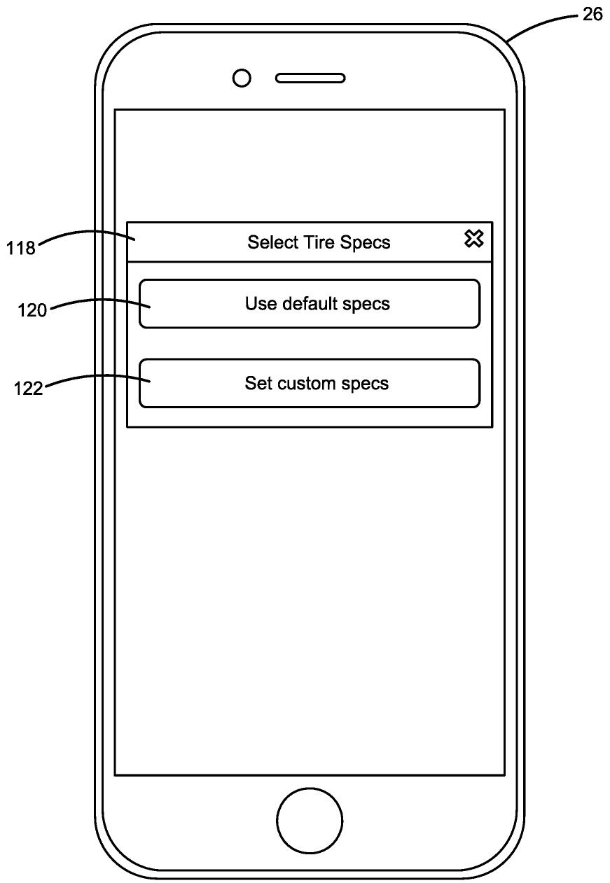

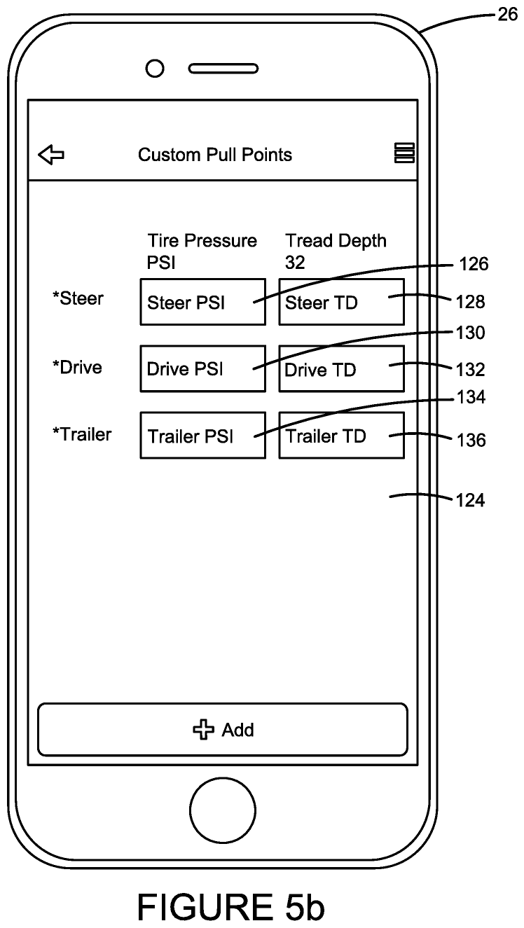

Because the data device 26 is in electronic communication with the server 34, the fleet data entered by the technician is uploaded to the server and stored. As a result, new fleet data only needs to be created once. As mentioned above, if this fleet has been inspected before, the technician confirms on the initial fleet display screen 100 the stored name 102 and/or location of the fleet lot 104. At step 56 (FIG. 3), when the technician confirms the stored name 102 and/or location of the fleet 104, the data device 26 recognizes the fleet information and proceeds to an initial vehicle or unit display screen 118 shown in FIG. 5a.

If this vehicle 10 has been inspected before, the technician confirms use of stored vehicle or unit data 120, as will be described in greater detail below. If this vehicle 10 has not been inspected before, the technician proceeds through a new or custom vehicle setup function 122 to a vehicle data entry screen 124, shown in FIG. 5b. In the vehicle data entry screen 124, the technician may enter vehicle or unit data, step 58 (FIG. 3), such as the configuration of the vehicle, including the type and number of axles and the number of tires on each axle, as well as target information for the particular vehicle configuration. For example, the configuration and target information may include a target tire pressure for tires on a steer axle 126, a target tread depth for tires on a steer axle 128, a target tire pressure for tires on a drive axle 130, a target tread depth for tires on a drive axle 132, a target tire pressure for tires on each trailer axle 134, and a target tread depth for tires on each trailer steer axle 136.

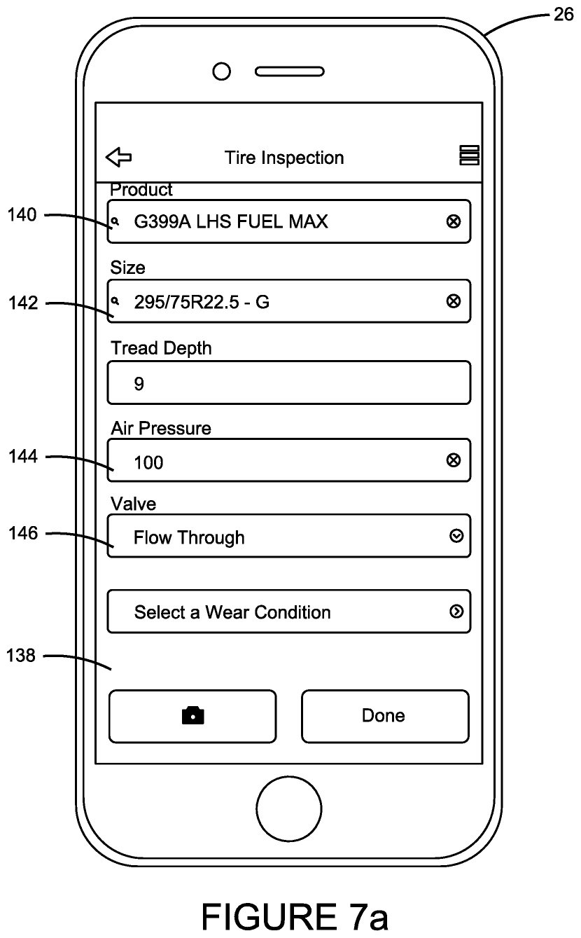

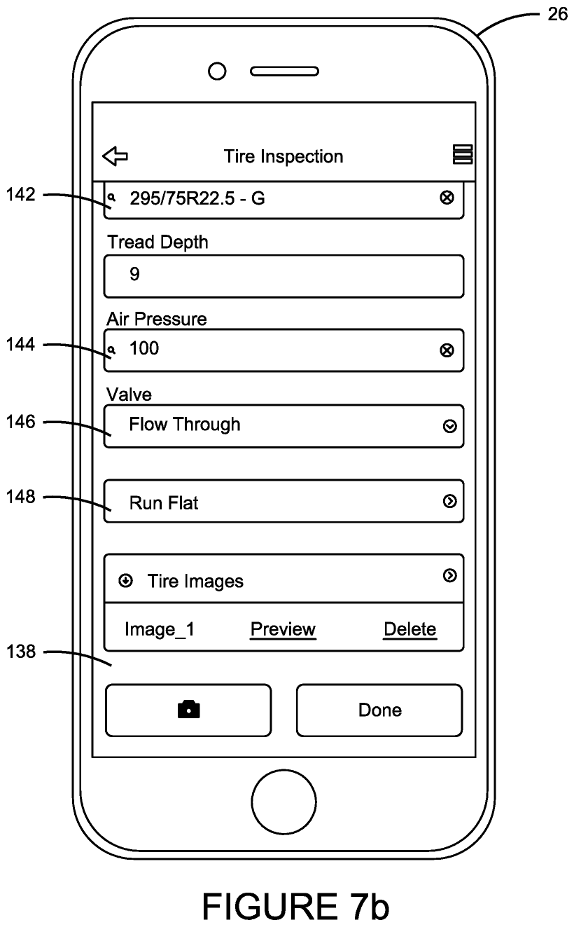

After entering the vehicle or unit data in step 58, the technician proceeds to enter static tire data using the data device 26, step 60 (FIG. 3). As shown in FIGS. 7a and 7b, the static tire data is non-measured tire data and is entered using a static tire data entry screen 138 on the data device 26. The static tire data includes tire type 140, tire size 142, any target tire pressure 144 not entered in the vehicle or unit data entry described above, tire valve type 146 and any additional tire information 148 that may be helpful in analyzing the tire 12. In addition, the static tire data may include the tire ID, which the technician acquires with the data device 26 as described above.

If this fleet and this vehicle have been inspected before, the data device 26 clones the previously-entered data from the last inspection of the vehicle, step 62 (FIG. 3). More particularly, because the data device 26 is in electronic communication with the server 34, the fleet data previously entered by a technician is uploaded to the server and stored. When the technician confirms that this fleet and this vehicle 10 have been inspected before in respective steps 52 and 56, the data may be returned from the server 34 to the data device 26 and thus cloned.

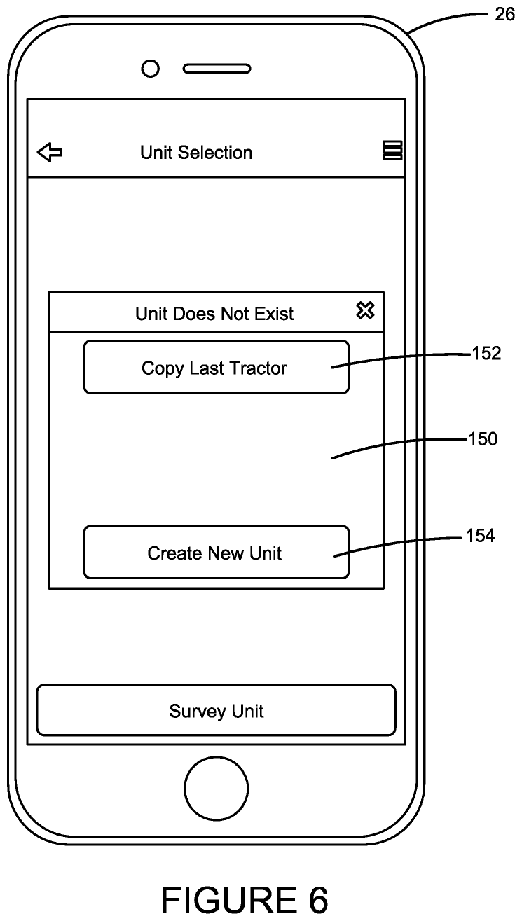

The technician confirms the prior inspection using a confirmatory screen 150 shown in FIG. 6, and may select an option 152 to clone the previously-entered data, including: the fleet data, including GPS location 108 or street address 116, fleet name 110, vocation or type of fleet 112 and/or fleet contact information 114; the vehicle or unit data, including the configuration of the vehicle, target tire pressure for tires on the steer axle 126, target tread depth for tires on the steer axle 128, target tire pressure for tires on the drive axle 130, target tread depth for tires on the drive axle 132, target tire pressure for tires on each trailer axle 134, and/or target tread depth for tires on each trailer steer axle 136; and the static tire data, including tire type 140, tire size 142, any target tire pressure 144 not entered in the vehicle or unit data entry, tire valve type 146, any additional tire information 148, and/or tire ID. The technician also has an option 154 to only clone the fleet data, and may thus manually enter the vehicle or unit data and the static tire data as described above in respective steps 58 and 60.

When the option 152 to clone the data is selected, the technician may review the cloned data and make any desired adjustments, step 64 (FIG. 3). For example, once the data is cloned, the data device 26 preferably displays the static tire data entry screen 138, shown in FIGS. 7a and 7b, for review and optional adjustment or updating by the technician.

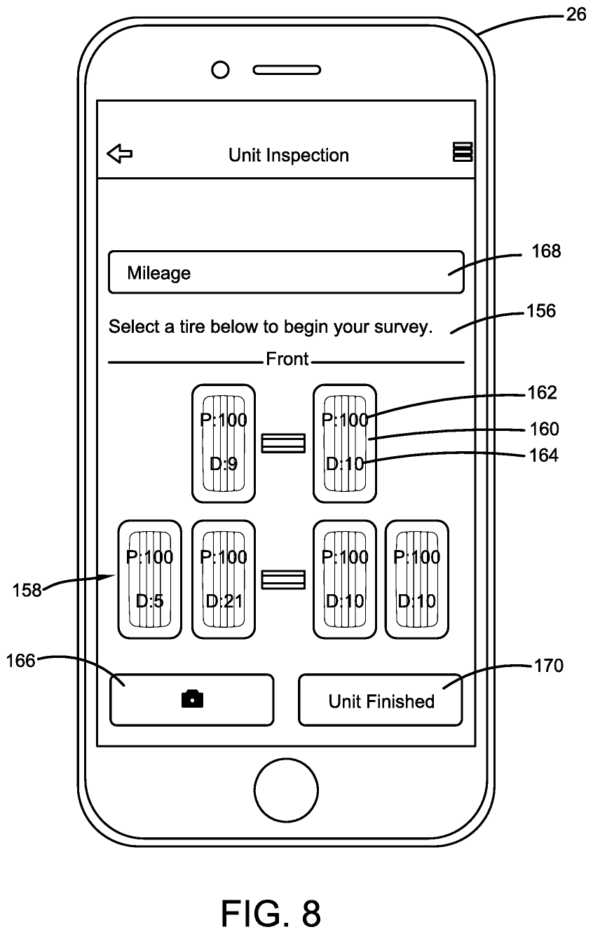

Once the static tire data has been entered pursuant to step 60, or the cloned data has been reviewed pursuant to step 64, the technician proceeds to gather the measured data for the tire 12, step 66 (FIG. 3). Referring now to FIG. 8, the data device 26 displays a measurement screen 156. In the measurement screen, a schematic representation of the tire configuration 158 on the vehicle 10 (FIG. 1) is displayed, which in turn includes individual tire representations 160. When an individual tire representation 160 is selected, the technician uses the portable inspection device 22 (FIG. 2) as described above to measure the pressure and tread depth of the tire 12 that corresponds to the selected tire representation. Also as described above, the pressure and tread depth of the tire 12 are wirelessly transmitted to the data device 26, and are recorded as a measured pressure 162 and a measured tread depth 164 for the selected tire representation 160 and thus the tire 12 which corresponds to the representation.

Optionally, if the technician sees an abnormality on a tire sidewall 14 and/or tread 18, he or she may use a photo function 166. The photo function 166 actuates a camera in the data device 26 to capture an image of a tire sidewall 14 and/or tread 18 as determined by the technician. The data device 26 correlates the image to the selected tire representation 160 and stores the image for upload to the server 34 as described above. In step 66, the technician repeats the measurement of tire pressure and tread depth for each tire 12 on the vehicle or unit 10 using each respective tire representation 160 in the tire configuration 158. The technician may optionally check and enter the vehicle or unit mileage 168 into the data device 26 as additional data to be uploaded to the server 34. The mileage entry 168 may be through an electronic interface with the vehicle 10 or manual entry by the technician.

Once all of the tires 12 on the vehicle or unit 10 have been inspected, and the tire pressure and tread depth for each loaded into the data measurement device 26, the technician acknowledges completion of the inspection for that vehicle through a unit finished function 170. Upon selection of the unit finished function 170, the technician may move on to another vehicle 10 to inspect the tires 12 of that vehicle or unit, step 68 (FIG. 3). When other vehicles or units 10 are to be inspected, step 56 is executed again, and steps 62, 64 and 66, or steps 58, 60 and 66, are repeated. When other vehicles or units 10 will not be inspected, the data in the data device 26 is uploaded to the server 34, step 70, as described above. Of course, because the data device 26 is in electronic communication with the server 34, the data from the data device may be uploaded to the server at more frequent intervals.

Referring now to FIGS. 2 and 3, as described above, the server 34 stores the data that was sent or uploaded by the data device 26. In step 72, upon request, the server 34 communicates the data to a data analysis device 36 for analysis of the data sent by the data device 26. Once the data is analyzed in step 72, recommendations and/or selected data sets are sent in step 74 from the data analysis device 36 to the server 34 and on to the managerial device 42 for the fleet. The information received by the managerial device 42 enables any recommendations to be implemented, such as pro-active repair and/or replacement of certain tires 12. Also in step 74, selected data sets or other information may be transmitted to the data device 26 for the above-described cloning of data or other feedback to the technician, thereby enabling an easy and rapid inspection with improved data accuracy and consistency.

An optional feature of the tire inspection system 8 includes specific geographic positioning for each tire 12 on each respective vehicle 10. More particularly, a GPS function may be employed in the data device 26 when the data device is proximate a specific tire 12 to provide a precise latitude coordinate and longitude coordinate for the position of the tire. Such geographic positioning for each tire 12 informs the technician of the location of each tire that needs to be inspected in a large lot of vehicles 10, thereby increasing the speed and efficiency of the inspection. The geographic positioning also enables multiple technicians to conduct inspections on the same fleet and coordinate their efforts, further increasing the speed and efficiency of the inspection.

An additional optional feature is of the tire inspection system 8 is an automatic generation of a work list by the data device 26. As the technician inspects each tire 12, the technician may enter items to be addressed for each tire, which are compiled into a work list by the server 34 and/or the data analysis device 36. The work list is sent from the server 34 to the fleet managerial device 42 and/or to the data device 26. As such attention items for each tire 12 are addressed, they may be checked off on the work list using the data device 26 and/or the fleet managerial device 42. The work list enables tracking of each tire 12 inspected, as well as the number of attention items that have been addressed, what the items were, and on which tires. Such tracking enables efficient and timely servicing for the tires 12 and tracking of such servicing.

The tire inspection system 8 of the present invention thus enables manual entry of fewer parameters during the inspection of each tire 12, and is consistent, with minimal subjectivity. The system 8 is therefore efficient and accurate, and enables rapid inspection of multiple tires 12 on each vehicle 10. In this manner, the tire inspection system 8 of the present invention provides a system for the inspection of tires 12 in a fleet of vehicles 10 that includes real-time gathering of tire data and efficient management of the data, thereby enabling an easily-executed, rapid tire inspection, and which also provides objective and consistent data. The tire inspection system 8 works for any fleet, regardless of the number of vehicles 10, and does not require any special hardware in the tires 12 or on the lot. The data collected by the tire inspection system 8 may be displayed immediately to the fleet management device 42 and/or the data device 26, and may also be retained in the server 34 for historical analysis and benchmarking purposes.

The present invention also includes a method for inspecting a tire 12 of a vehicle 10 in a fleet. The method includes steps and features in accordance with the description that is presented above and shown in FIGS. 1 through 8.

It is to be understood that the structure of the above-described tire inspection system may be altered or rearranged, or components or steps known to those skilled in the art omitted or added, without affecting the overall concept or operation of the invention. The invention has been described with reference to preferred embodiments. Potential modifications and alterations may occur to others upon a reading and understanding of this description. It is to be understood that all such modifications and alterations are included in the scope of the invention as set forth in the appended claims, or the equivalents thereof.

What is claimed is:

1. An inspection system for a tire of a vehicle in a fleet, the system comprising:
a portable inspection device including means for measuring a tire pressure, means for measuring a tread depth of the tire, and an antenna for wireless communication;
a hand-held data device including a processor, memory and an antenna for wireless data transmission, wherein the data device receives the measured tire pressure and the measured tread depth of the tire from the portable inspection device;
a server remote from the data device;
a first wireless transmission means to upload the measured tire pressure and the measured tread depth of the tire from the data device to the server;
an analysis device in electronic communication with the server for analysis of the data uploaded from the data device; and
a second wireless transmission means to communicate cloned data sets from the server to the data device.

2. The inspection system for a tire of a vehicle in a fleet of claim 1, wherein the cloned data sets include at least one of fleet data, vehicle data and static tire data.

3. The inspection system for a tire of a vehicle in a fleet of claim 1, wherein the data device includes data entry screens for manual entry of at least one of fleet data, vehicle data and static tire data.

4. The inspection system for a tire of a vehicle in a fleet of claim 1, wherein the data device includes means for acquiring a tire identification code.

5. The inspection system for a tire of a vehicle in a fleet of claim 1, wherein the data device includes a camera to capture an image of at least one of a sidewall and a tread of the tire.

6. The inspection system for a tire of a vehicle in a fleet of claim 1, wherein the second wireless transmission means also communicates at least one of recommendations and selected data sets generated by the analysis device from the server to at least one of a managerial device and the data device.

7. A method for inspecting a tire of a vehicle in a fleet, the method comprising the steps of:
determining if the inspection is a first inspection for the fleet;
if the inspection is a first inspection for the fleet, entering fleet data into a hand-held data device;
determining if the inspection is a first inspection for the vehicle;
if the inspection is a first inspection for the vehicle, entering vehicle data into the data device and entering static tire data into the data device;
if the inspection is not a first inspection for the fleet and the vehicle, cloning previously-entered fleet data, vehicle data and static tire data on the data device;
selecting a tire representation on the data device that corresponds to the tire to be inspected;
measuring an inflation pressure and a tread depth of the tire to be inspected with a portable inspection device;
transmitting the measured inflation pressure and tread depth from the portable inspection device to the data device;
correlating the measured inflation pressure and tread depth to the selected tire representation on the data device; and
transmitting the fleet data, vehicle data, static tire data, the measured inflation pressure and the measured tread depth to a remote server.

8. The method for inspecting a tire of a vehicle in a fleet of claim 7, wherein the step of cloning the previously-entered fleet data, vehicle data and static tire data includes transmitting the previously-entered fleet data, vehicle data and static tire data from the remote server to the data device.

9. The method for inspecting a tire of a vehicle in a fleet of claim 7, wherein the fleet data includes at least one of a geographic location, a street address, a fleet name, a fleet type and fleet contact information.

10. The method for inspecting a tire of a vehicle in a fleet of claim 7, wherein the vehicle data includes at least one of a type of axles on the vehicle, a number of axles on the vehicle, a number of tires on each axle, a target inflation pressure for each tire, and a target tread depth for each tire.

11. The method for inspecting a tire of a vehicle in a fleet of claim 7, wherein the static tire data includes at least one of a tire type, tire size, a target tire inflation pressure, a tire valve type, and a tire identification code.

12. The method for inspecting a tire of a vehicle in a fleet of claim 7, further comprising the step of reviewing and adjusting the cloned data on the data device.

13. The method for inspecting a tire of a vehicle in a fleet of claim 7, further comprising capturing an image of at least one of a sidewall and the tread of the tire with a camera in the data device and correlating the image to the selected tire representation.

14. The method for inspecting a tire of a vehicle in a fleet of claim 7, further comprising the step of repeating the measurement of inflation pressure and tread depth for each tire on the vehicle.

15. The method for inspecting a tire of a vehicle in a fleet of claim 7, further comprising the step of analyzing the data transmitted to the remote server with an analysis device.

16. The method for inspecting a tire of a vehicle in a fleet of claim 15, further comprising the step of transmitting at least one of recommendations and selected data sets from the analysis device to the server and to at least one of a managerial device and the data device.

17. The method for inspecting a tire of a vehicle in a fleet of claim 7, further comprising the step of locating the geographic position of the tire to be inspected with a global positioning system.

18. The method for inspecting a tire of a vehicle in a fleet of claim 7, further comprising the step of generating a work list from the tire inspection using the data device.
